(19) United States
(12) Patent Application Publication
(10) Pub. No.: US 2003/0040980 A1
(43) Pub. Date: Feb. 27, 2003

(54) System and method for delivering and receiving purchased articles using lockers

(75) Inventors: Amane Nakajima, Tokyo-to (JP); Hiroshi Kurahashi, Fujisawa-shi (JP); Yoshihiko Ohta, Yokohama-shi (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/223,408

(22) Filed: Aug. 19, 2002

(30) Foreign Application Priority Data
Aug. 21, 2001 (JP) 2001-249526

(51) Int. Cl. G06F 17/60

(52) U.S. Cl. 705/26

(57) ABSTRACT

An article delivery method and system for improving customer convenience. An article ordered by a customer is delivered by a delivery service to a locker specified by the customer. At the time of delivering the article, a delivery person uses a delivery password indicated in advance by a commerce server to unlock a compartment of the specified locker and places the article in the compartment. Then, the compartment is locked. To receive the article, the customer uses a pre-specified receipt password to unlock the compartment and retrieve the article.

### FIELD OF THE INVENTION

The present invention relates to a method and system for delivering and receiving a purchased article.

### BACKGROUND

In recent years, an explosion in the use of personal computers (hereinafter abbreviated to “PCs”) has encouraged the widespread adoption of Internet shopping.

In Internet shopping, a customer (user) accesses an electronic store through his/her PC to place an order for a desired article via the Internet. Once the order is placed, however, the transaction in fact is performed off the Internet. The electronic store consigns the article to a delivery service company along with a slip bearing an address specified by the customer. Then, the delivery service company delivers the article to the customer at the address provided on the slip. However, this method has clear shortcomings in the areas of convenience in that the customer must be at home when the commodity is delivered unless the customer lives in an apartment with parcel receipt lockers. This is inconvenient for those customers who are away from home on business most of the time.

The commodity can be delivered to the customer's place of work, for example. However, the customer then must carry it home. In some cases, it may be difficult for the customer to receive the commodity at his/her work place.

Thus there is a need for an article delivery method, article delivery system, and other components that can provide better convenience for the customer.

### SUMMARY

An article delivery method according to the present invention comprises the steps of receiving an order for an article to be delivered over a network and receiving a specification of a locker to which an article is to be delivered along with personal information such as the address and name of the orderer (or a recipient, if the orderer is not the recipient) of the article. For example, the location of the locker may be specified as “a locker at xxx station.”

Identification-recipient information such as a password or ID is registered in advance for identifying the recipient when the recipient unlocks the locker to receive the article.

Delivery request data including article-identification information for identifying the article ordered and locker information indicating the specified locker is provided in order to request the delivery of the article. A delivery person places the article in the specified locker with reference to the delivery request data.

When the recipient inputs the recipient identification information at the locker, the locker containing the article is unlocked and the recipient can receive the ordered article.

In this way, the customer can receive the article at the locker specified by the customer, instead of at his/her home, office, or a convenience store.

A delivery password may be included in the delivery request data and used to allow the locker to be locked when the article is placed in the locker. The delivery password included in the delivery request data is input by the delivery person. If the locker has been locked before the article is placed in the locker, the delivery password can be used to unlock the locker.

The delivery password or the recipient identification information should preferably be invalidated after the locker is locked by using the delivery password or after the locker is unlocked by using the recipient identification information.

At the step of unlocking the locker in order to receive the article, the locker may be unlocked only if payment for the ordered article has been completed. If payment for the article has not been completed, the locker is not unlocked until it is completed. In such a case, payment can be made at the locker, that is, the payment can be made on a cash-on-delivery (COD)basis.

In an article delivery system according to the present invention, specification of a locker to which an article is to be delivered is received from the recipient or sender of an article by a receiving means. A receipt password used by the recipient of the article to unlock the locker and a delivery password used by the delivery person of the article to unlock the locker are registered in a password registration means. Entry control means locks the locker when the delivery person inputs the delivery password and places the article in the locker. When the recipient of the article inputs the receipt password, retrieval control means unlock the locker to allow the recipient to receive the article contained in the locker.

Examples of such an article include a commodity ordered over the Internet as well as a mail-order commodity ordered by telephone rather than a network, and an article requested by a customer to be delivered, such as a washed garment to be sent off by a laundry. The article delivery system is suited for delivery of any of these articles.

The present invention can be viewed as a locker management server for managing a locker to which an article is delivered. The locker management server comprises a locker specification receipt module for receiving specification of a locker and a password registration module for registering a first password for unlocking the locker when the delivered article is placed in the locker, and a second password for unlocking the locker when the article is taken out of the locker.

When a locker or the location of a locker is specified, the locker specification receipt module determines whether the particular locker or any of lockers installed at the location is available and, if the locker is available, accepts the locker as the address for delivery. A locker herein may have of a plurality of compartments. If any of these compartments is available, a locker is available.

In addition, specification of a valid period for which a delivered article can be stored in a specified locker may be received. For example, if the article contained in the locker is not retrieved within a predetermined period, the fact may be reported. The valid period can be used to monitor the availability of the locker.

The present invention can be viewed as a locker locking/unlocking apparatus. In the apparatus, a lock controller controls locking/unlocking of a locker and a first and second passwords transmitted from an external source over a network are registered in a registration module. When the first password is input in order to place an article to be delivered in the locker, the locker is unlocked. After the article is placed in the locker, the locker is locked. When the second password is input in order to take the article out of the locker, the locker is unlocked.

A sensor may be attached to the locker locking/unlocking apparatus for detecting the presence of an article in the locker article, thereby determining whether an article is actually contained in the locker when the article is supposedly placed in the locker or retrieved from the locker. If an abnormal condition is detected, it can be reported.

The present invention can be viewed as an article delivery request receiving apparatus for receiving a request for delivery of an article at an electronic store. When the apparatus receives specification of a locker to which an article is to be delivered and customer identification information for identifying a customer provided from a customer's terminal over a network, and accepts a request for delivery of an article. The apparatus sets an unlocking password for unlocking the locker and indicates the unlocking password to the customer's terminal. The apparatus then outputs locker identification information and article identification information for delivering the article to the specified locker. A delivery service company delivers the article based on the locker identification information and article identification information without necessarily knowing the customer identification information.

The unlocking password may be indicted to the customer's terminal only after the payment for the article, or payment for delivery of the article, is completed. The customer therefore must have completed the payment before he/she can unlock the locker.

### BRIEF DESCRIPTION OF THE DRAWINGS

FIG. 1 shows a configuration of an article delivery system according to the present embodiment;

FIG. 2 shows a process flow from order to delivery of an article;

FIG. 3 shows an example of commodity inventory information;

FIG. 4 shows an example of commerce information;

FIG. 5 shows an example of information about availability of lockers;

FIG. 6 shows an example of password information;

FIG. 7 shows an example of delivery information;

FIG. 8 shows a process flow for delivering an article to a locker;

FIG. 9 shows an example of information about entry/retrieval of an article in a locker;

FIG. 10 shows a process flow for receiving an article delivered to a locker; and

FIG. 11 shows a process flow for managing a receive-by date of an article contained in a locker.

### DETAILED DESCRIPTION

The present invention will be described below with respect to an embodiment shown in the accompanying drawings.

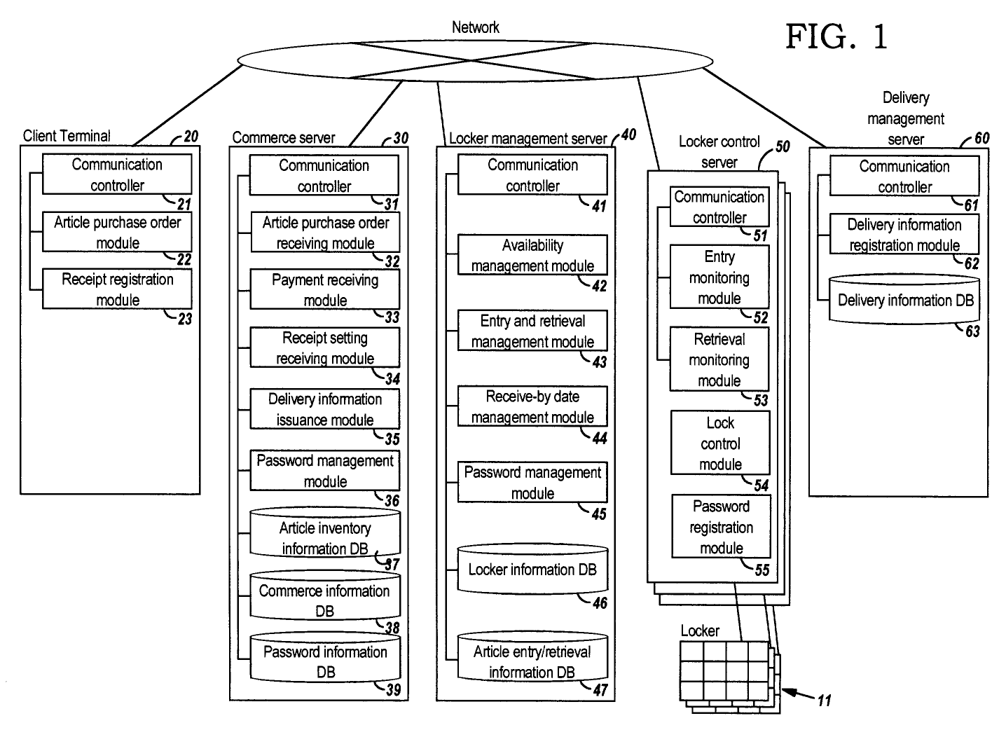

FIG. 1 shows a configuration of an article delivery system according to the embodiment. In this article delivery system, a customer (delivery requester or recipient) places an order for an article with an electronic store over a network 10 such as the Internet or the like. A delivery service company delivers the article to a locker specified by the customer, as shown in FIG. 1.

A client terminal 20 of the customer, a commerce server (article delivery request receipt apparatus) 30 of the electronic store, a locker management server 40 of a locker management company, a locker control server (locker open/close control apparatus) 50 for controlling lockers 11 in various locations, and a delivery management server 60 of the delivery service company can connect to the network 10.

The customer's client terminal 20 may be a personal computer, a personal digital assistant, or a mobile phone that has a CPU, memory, an external storage such as a hard disk drive, an input device such as a keyboard and mouse, an output device such as a monitor, and a communication controller 21 for communications over the network 10. The client terminal 20 performs a process according to a given program to provide the functions of an article purchase order module 22 for placing an order for an article with the electronic store and a receipt registration module 23 for performing various settings and registrations for receiving the article.

The commerce server 30 of the electronic store includes a communication controller 31 for communications over the network 10, an article purchase order receipt module (order receipt module) 32 for receiving an article purchase order from the client terminal 20, a payment receipt module (payment processing module) 33, a receipt setting receiving module (receiving means, locker specification receiving module, delivery request receiving module) 34 for receiving various settings required for the customer to receive the article, a delivery information issuance module (information output module) 35 for issuing a delivery number and delivery password used for delivering the article, a password management module (password registration means, password setting module) 36 for managing various passwords, a commodity inventory information database (DB) 37, a commerce information DB 38, and password information DB 39.

The locker management server 40 centrally manages lockers 11 installed in various locations managed by locker management companies. The locker management server 40 includes a communication controller 41 for communications over the network 10, an availability management module 42 for managing availability of the lockers 11 in various locations, an entry and retrieval management module 43 for monitoring the entry and retrieval of an article (commodity) in the lockers 11, a receive-by date management module (expiration data management module) 44 for managing the receive-by date of the articles (commodities) delivered to the lockers 11, a password management module (password registration module) 45 for managing passwords used for the entry or retrieval of articles in the lockers 11, a locker information DB 46 containing data about the availability of the lockers 11, and an article entry/retrieval information DB 47 containing information about entry/retrieval of the articles in the lockers 11.

While the locker management server 40 is provided separately from the commerce server 30 in the exemplary embodiment of FIG. 1, they may be provided as a single server if the same service provider manages both. In such a case, duplication is not required of components such as the communication controllers 31 and 41, the password management modules 36 and 35 that have the same functions.

The locker control server 50 controls each of the lockers 11 installed in each location. A locker may preferably be installed in a place with a large amount of customer traffic, such as a train station, bus stop, convenience store, and post office. The lockers 11 may be existing coin-operated lockers. Each of the lockers 11 may have a plurality of compartments, doors (not shown) provided for the individual compartments, lock mechanisms for locking these doors (lock control module, not shown), lock control mechanism (not shown) for controlling locking and unlocking of the lock mechanisms. Each compartment may include a sensor for sensing whether the door is open or closed, and a weight sensor and object sensor for detecting whether an article is contained in the compartment. A refrigeration function may also be provided.

The locker control server 50 has a communication controller 51 for communications over the network 10 (or a dedicated network enabling communications with the locker management server 40), an entry monitoring module (entry control means) 52 for monitoring delivery by a delivery person of articles to the compartments, and a retrieval monitoring module (retrieval control means) 53 for monitoring retrieval by customers of the articles from the compartments, a lock control module 54, and a password registration module 55.

The delivery management server 60 of the delivery service company has a delivery information registration module 62 for delivery management and a delivery information DB 63 storing delivery information (delivery request data) as well as a communication controller 61 for communications over the network 10.

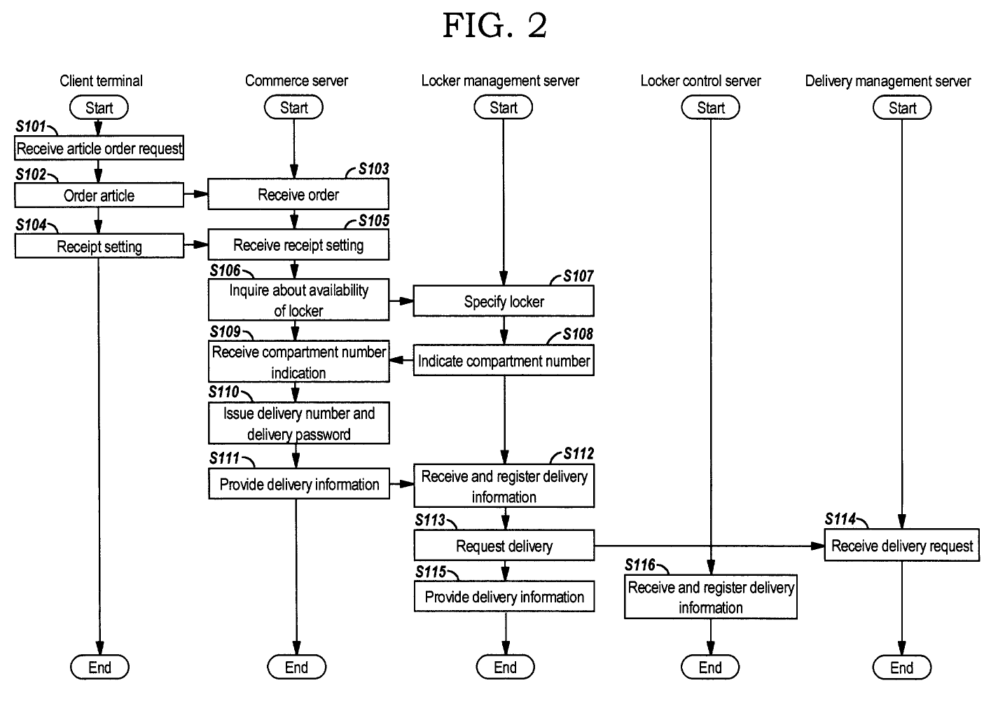

FIG. 2 shows an exemplary process flow from placing an order for an article to requesting delivery.

The customer at the client terminal 20 browses articles made available by an electronic store on a Web page provided by the commerce server 30 and chooses a desired article. The customer then uses his/her ID, which has been registered in advance, as personal information about the customer to perform a request operation for placing an order for the desired article through the client terminal 20. The customer may indicate personal information such as his/her name, address, and telephone number to the commerce server 30. If the ID of the customer has been registered previously in association with the personal information in an ID registration server (not shown) adjunct to the commerce server 30, the customer may place the order simply by presenting his/her ID to the commerce server 30.

The article purchase order module 22 of the client terminal 20 receives the article order request (step S101) and sends the request to the commerce server 30 of the electronic store through the communication controller 21 over the network 10 (step S102).

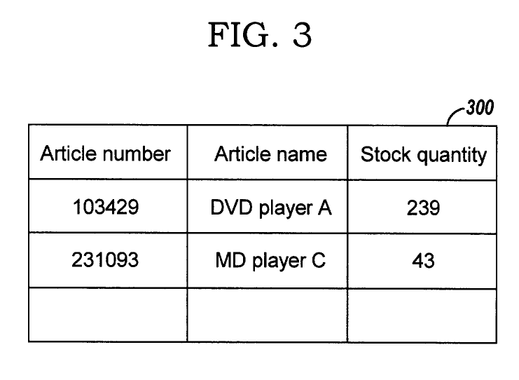

The article purchase order receipt module 32 of the commerce serve 30 receives the order from the client terminal 20 through the network 10 and the communication controller 31 and references data in the commodity inventory information DB 37 to check the stock of the ordered article. FIG. 3 shows an example of inventory data 300 contained in the commodity inventory information DB 37.

If the article is in stock, the article purchase receipt module 32 accepts the order and notifies the client terminal 20 of the acceptance of the order (step S103).

At the same time, a payment receiving module 33 in the commerce server 30 may request the customer to pay for the ordered article. When the customer receives the request through the client terminal 20, the customer selects and specifies a payment option, which may include credit cards and bank transfers, and inputs required information required for conventional Internet shopping. The commerce server 30 receives the specification and information. In this embodiment, the payment receiving module 33 may receive “payment on delivery” made by the customer at one of the lockers 11 when he/she receives the article.

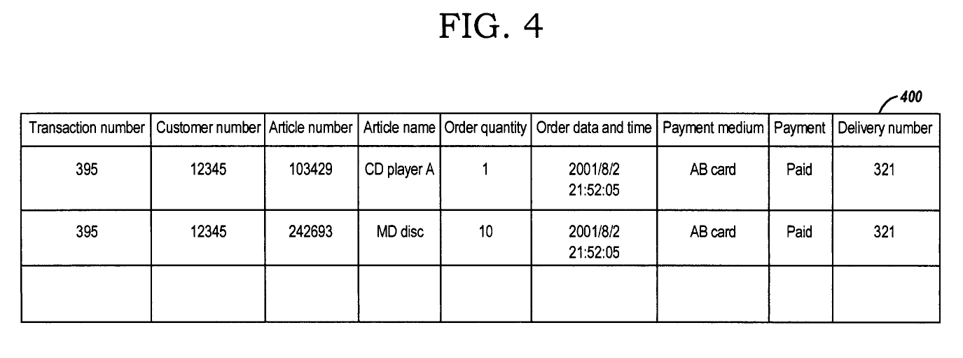

FIG. 4 shows an example of commerce information 400 generated in the commerce server 30 when the article is ordered by the customer as described above. The commerce information 400 includes the ID of the customer, type and quantity of the ordered article (article identification information), payment information, and an indication of whether payment is completed. The commerce information 400 is stored in the commerce information DB 38.

After ordering the article, the customer provides information required for receiving the article (step S104). The customer receives information such as a list of available lockers, which is registered beforehand, and specifies an area and place in which the locker is installed where he/she wants to receive the article. The customer may specify a receipt date and time. The customer also specifies a receipt password (receipt identification information, unlocking password, or second password), which he/she uses in the valid receipt period to receive the article. A valid receipt period may be automatically set by the electronic store that has received the order under an agreement between the electronic store and the delivery service company that delivers the article.

The receipt setting receiving module 34 in the commerce server 30 receives the information about the locker to which the article is to be received and the valid receipt period, the receipt password, and other information provided from the client terminal 20 as described above (step S105).

The receipt setting receiving module 34 queries the locker management server 40 about the availability of the locker specified by the customer (step S106). The receipt setting receiving module 34 also indicates to the locker management server 40 an expected delivery date (and time) of the article and the valid receipt period as well as conditions such as the size and quantity of the article ordered by the customer and whether cold storage is required.

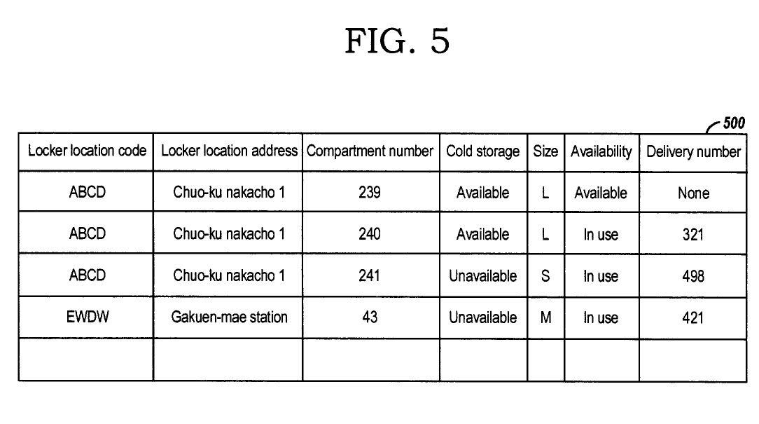

The locker management server 40 receives the inquiry from the receipt setting receiving module 34 through the communication controller 41, searches the locker information DB 46 for data about the number of days from expected arrival date to the receive-by date of the article and whether (a compartment of) a locker meeting the specified conditions is available. FIG. 5 shows an example of data indicating availability 500 of lockers that is stored in the locker information DB 46.

If any of the lockers 11 that meets the conditions is available, the availability management module 42 specifies a compartment of that locker as the destination of the article (step S107), reserves the compartment and updates the locker information DB 46 so that unavailability of the compartment can be indicated if another inquiry about the availability of the locker is received subsequently. Then the availability management module 42 indicates the number of compartment of the locker specified as the delivery destination to the commerce server 30 (step S108).

If no locker meeting the conditions is available at step S107, the locker management server 40 indicates the fact to the commerce server 30. The commerce server 30 then requests the client terminal 20 to specify another locker.

The commerce server 30 receives the indication from the locker anagement server 40 and the receipt setting receiving module 34 receives the indication of the compartment number (locker information) (step S109), associates it with commerce information about the article ordered by the customer, and stores it in the commerce information DB 38.

Then, the delivery information issuance module 35 of the commerce server 30 issues a delivery number, which is mainly used by the delivery service company for managing delivery of the ordered article to the locker. The delivery information issuance module 35 issues a delivery password (first password or locking password), which is required for the delivery service company to deliver the article and place it in the appropriate compartment of the selected locker (step S110).

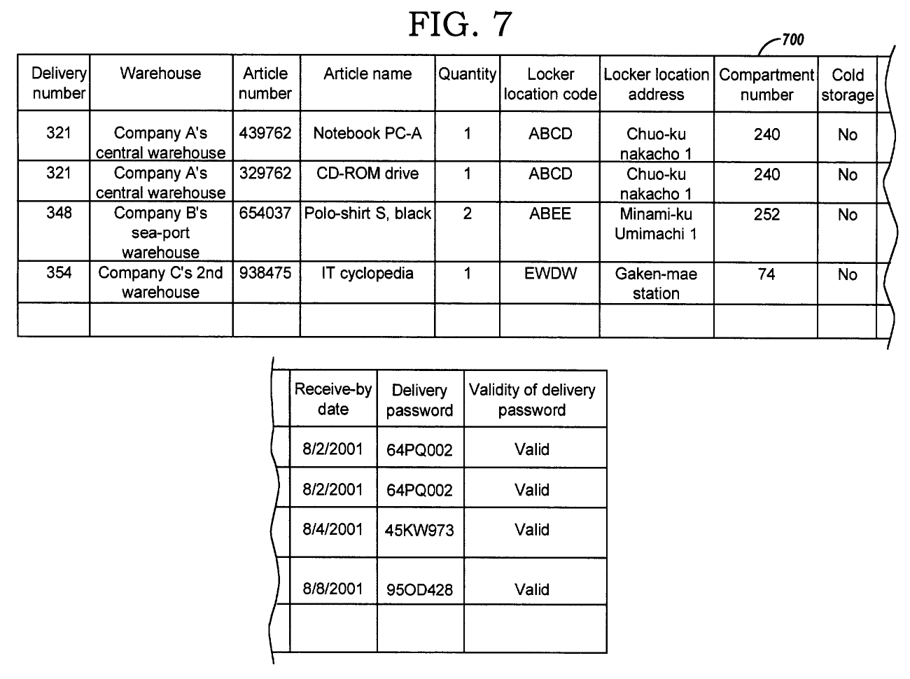

The delivery information issuance module 35 generates delivery information 700 which may include, as shown in FIG. 7, the delivery number, the delivery password, the customer ID (the input of which is optional), information indicating the type and quantity of the ordered article, a warehouse in which the article is stored, the location of the selected locker and the number of the compartment to which the article is to be delivered, receive-by date, whether refrigeration is required, and other items of information, including the receipt password, received at step S105, and provides the delivery information 700 to the locker management server 40 (step S111).

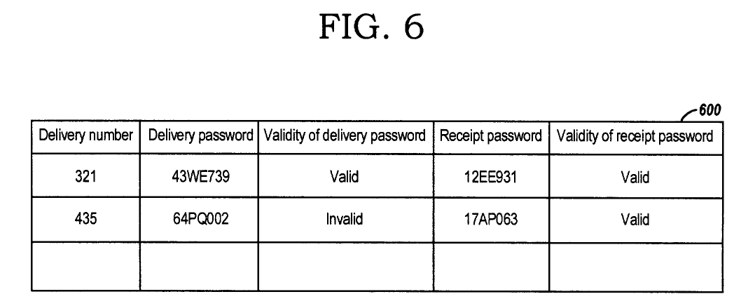

The password management module 36 stores the delivery number and delivery password issued in the password information DB 39 along with the receipt password received at step S105. FIG. 6 shows an example of the password information 600 stored in the password information DB 39.

The delivery information provided from the commerce server 30 at step S111 is received by the locker management server 40 and stored (registered) in the article entry/retrieval information DB 47 (step S112). Then the locker management server 40 indicates to the delivery management server 60 the type and quantity of the article to be delivered, the warehouse in which the article is stored, the location of the selected locker and the compartment number to which the article is to be delivered, whether cold storage is required, the delivery number, and the delivery password, and requests the delivery of the article (step S113). The delivery management server 60 receives the request from the locker management server 40 (step S114). The locker management server 40 provides minimum required information about the delivery of the article. It does not necessarily provide information such as the ID, name, address of the customer or the receipt password to be used by the customer.

The locker management server 40 indicates the delivery number, the delivery password, the location of the locker to which the article is to be delivered, the compartment number, the receive-by date, whether cold storage is required, and the receipt password to the locker control server 50 of the locker to which the article is to be delivered (step S115). The locker control server 50 receives this information and stores it in the password registration module such as memory, which is not shown (step S116).

The delivery service company receives the delivery request from the locker management server 40 through the delivery management server 60 and delivers the article. In particular, the delivery service company indicates the information about the delivery request to a delivery person. The delivery person receives, based on the information, the article from the warehouse in which it is stored and delivers it to the specified locker.

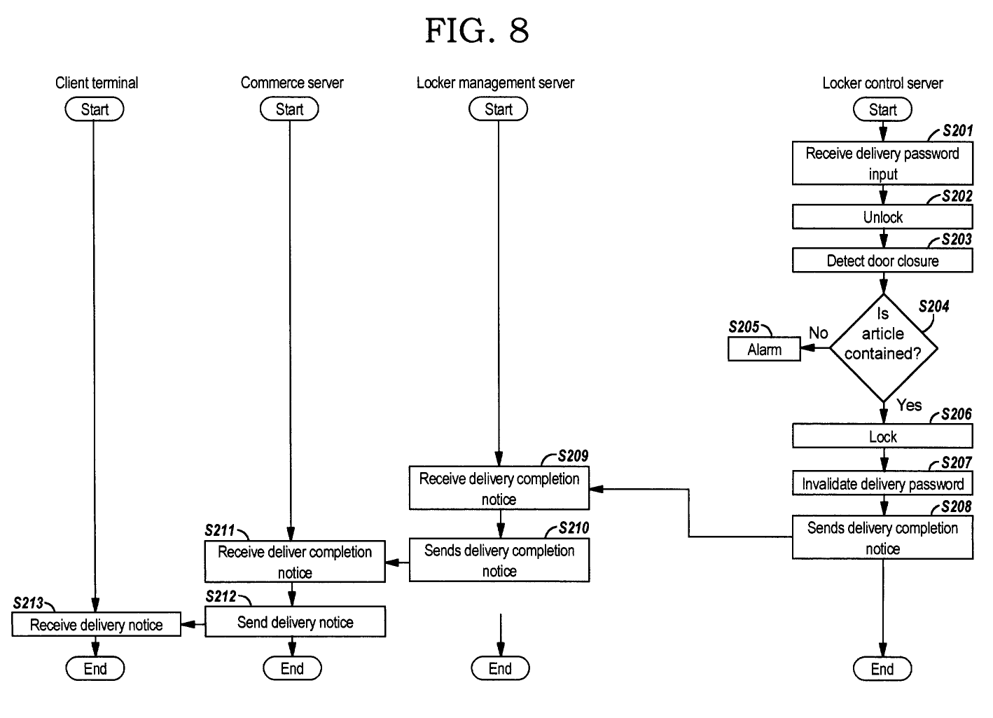

As shown in FIG. 8, the delivery person inputs the delivery number and delivery password included in the delivery request information, which the entry monitoring module 52 of the locker control server 50 receives (step S201).

If the input delivery number and password have a match stored in the password registration module, the specified compartment of the locker is unlocked (step S202).

The delivery person opens the door of the unlocked compartment, places the article in the compartment, then closes the door. A sensor (not shown) of the entry monitoring module 52 detects the door closure (step S203). Then a weight sensor or object sensor (not shown) of the entry monitoring module 52 provided in the compartment detects whether an article is contained in the compartment (step S204). If no article is detected in the compartment, then the entry monitoring module 52 determines that abnormal conditions occur and sends an alarm to the locker management server 40 (step S205). The locker management server 40 receives the alarm and performs predetermined actions such as checking to see if the article has been shipped. The alarm may also be sent from the locker control server 50 to the locker management server 40 in other abnormal cases, such as a case where more than an allowable number of invalid delivery passwords are input or the door of the compartment is not closed after a predetermined period of time elapses since the door was opened.

On the other hand, if an article is detected in the compartment, the entry monitoring module 52 locks the door of the compartment (step S206) and invalidates the delivery password (step S207). Then the locker control server 50 sends a notice of delivery completion to the locker management server 40 (step S208).

The locker management server 40 receives the notice of delivery completion and updates the article entry/retrieval information DB 47 (step S209). The locker management server 40 then sends the notice of delivery completion to the commerce server 30 (step S210).

The commerce server 30 receives the notice of the delivery completion and uses it to update the commerce information DB 38 (step S211). The commerce server 30 then sends by e-mail, for example, to the client terminal 20 a delivery notice indicating that the article has been delivered and prompting the customer to receive the article by the specified delivery-by date (step S212).

The delivery notice may be sent from the locker management server 40 or the delivery management server 60 to the client terminal 20. However, it may be preferable that the notice be sent from the commerce server 30 as described above in order to keep personal information about the customer, such as the mail address of the customer, from being disclosed to the locker management company or delivery service company.

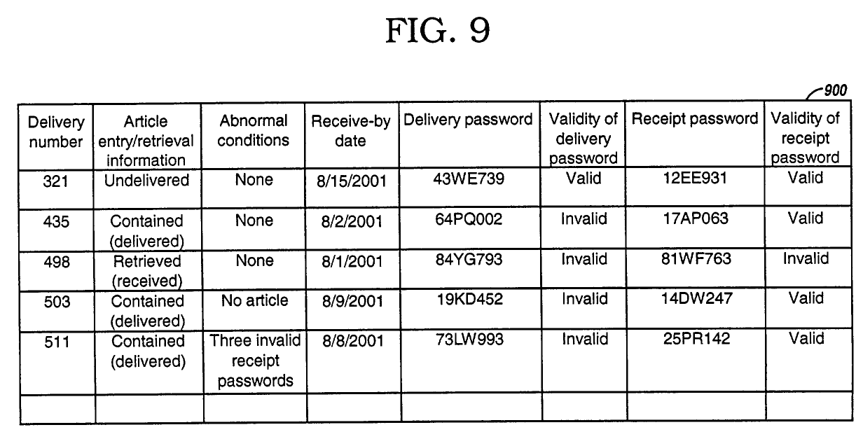

FIG. 9 shows an example of article entry/retrieval information 900 stored in the article entry/retrieval DB 47 of the locker management server 40 in the process described above.

The customer receives the delivery notice from the commerce server 30 at the customer's client terminal 20 (step S213), then goes to the locker to which the article has been delivered to receive the article by the receive-by date specified in the delivery notice.

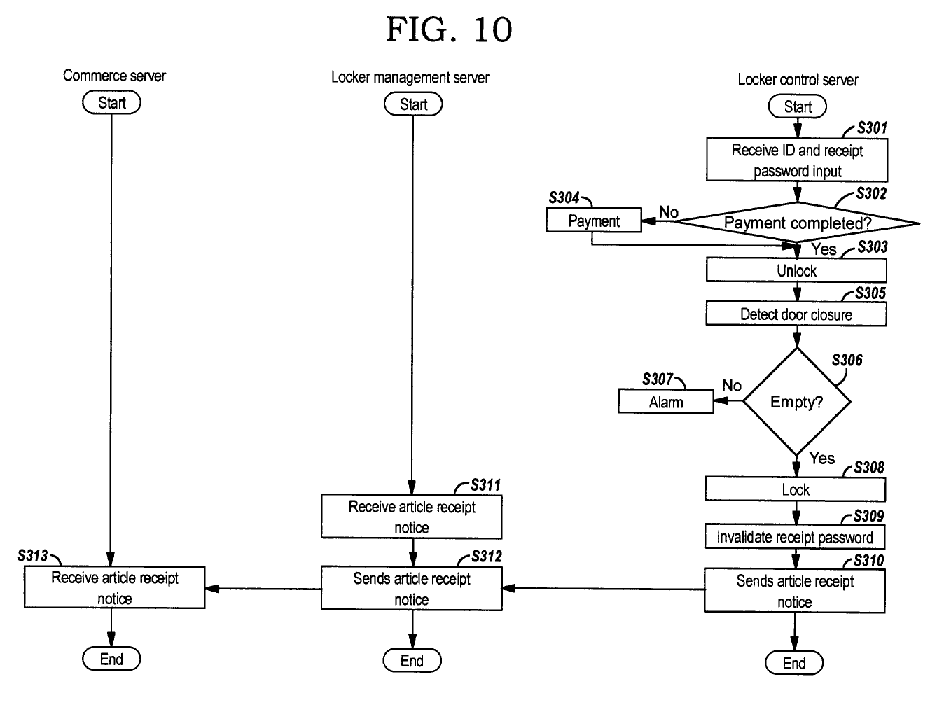

As shown in FIG. 10, the customer inputs his/her ID and receipt password, which the retrieval monitoring module 53 of the locker control server 50 controlling the locker receives (step S301).

If the input ID and receipt password have a match stored in the password registration module, then a determination is made whether payment for the delivered article has been completed by the customer (step S302).

If payment has been completed, the compartment of the locker is unlocked (step S303).

If payment has not been completed, the customer makes the payment (step S304) and, after the completion of the payment, the compartment of the locker is unlocked (step S303). For this, the locker should include a payment collection module (not shown). The payment collection module (not shown) has the function of accepting a credit card, debit, prepaid card, electronic money, or cash, for example, to collect specified payment. If existing coin-operated lockers are used as the lockers 11, the originally included cash collection mechanisms can be used for this payment collection.

Steps S302 and S304 relating to payment are optional, depending on a system configuration.

After the compartment of the locker is unlocked, the customer opens the door of the compartment, takes the article out of the compartment, then closes the door. A sensor (not shown) of the article retrieval monitoring module 53 detects that the door closed (step S305). Then, a weight sensor or object sensor, which is not shown, provided in the compartment detects whether any article is contained in the compartment (step S306). If it detects that an article is contained in the compartment, that is, the article has not been taken out of the compartment or another article is left in it, the article retrieval monitoring module 53 sends an alarm to the locker management server 40 to indicate the abnormality (step S307). The locker management server 40 receives the alarm and performs a predetermined action such as sending e-mail to the client terminal 20 through the commerce server 30 to check with the customer. The alarm may also be sent from the locker control server 50 to the locker management server 40 in other abnormal cases, such as a case where more than an allowable number of invalid delivery passwords are input or the door of the compartment is not closed after expiration of a predetermined period of time.

On the other hand, if no article is contained in the compartment, the retrieval monitoring module 53 locks the compartment (step S308), and then invalidates the receipt password (step S309). Then the locker control server 50 sends an article receipt completion notice to the locker management server 40 (step S310).

The locker management server 40 receives the article receipt completion notice and updates the locker information DB 46 and the article entry/retrieval information DB 47. As a result, the locker information DB 46 indicates that the compartment of the locker that contained the article is now empty (step S311). The locker management server 40 sends the article receipt completion notice to the commerce server 30 (step S312). The commerce server 30 receives it and updates relevant data to indicate that the business transaction has been completed (step S313).

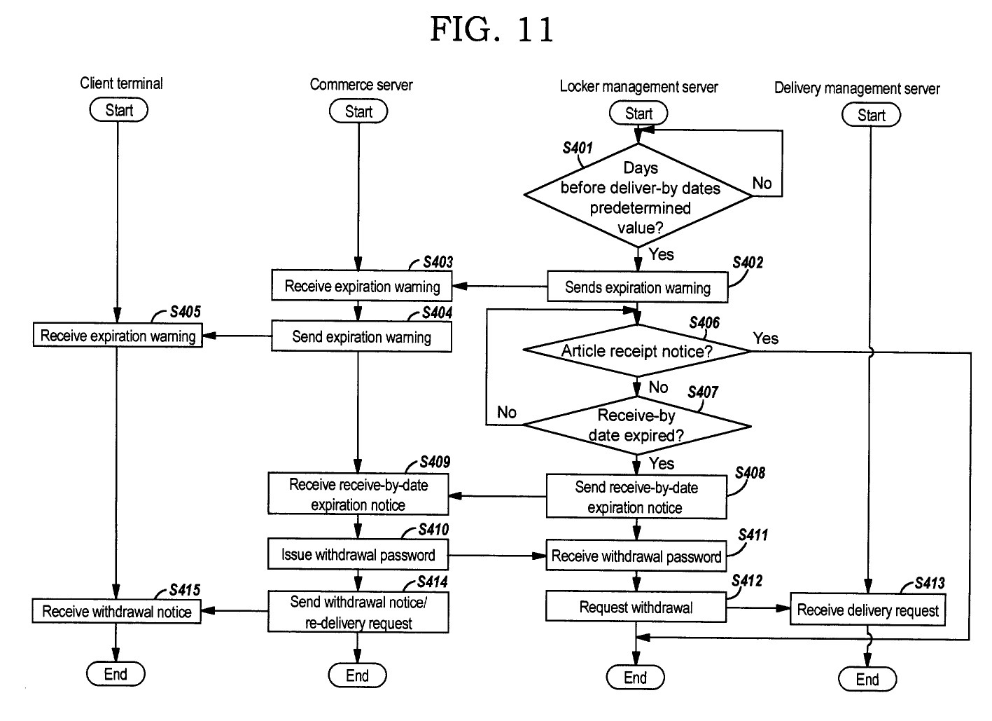

As described earlier, the present invention is arranged so that a receive-by date can be set for the article. The locker management server 40 (or the locker control server 50) performs monitoring based on the receive-by date. After receiving the delivery completion notice at step S209, the locker management server 40 keeps on checking to see if the number of days remaining before the specified receive-by date is less than or equal to a predetermined number (step S401), as shown in FIG. 11. It repeats step S401 until the number becomes equal to or less than the predetermined number, then proceeds to the next step, S402.

At step 402, the locker management server 40 sends an expiration warning notice to the commerce server 30 (step S402).

The commerce server 30 receives the expiration warning (step S403), then sends an expiration warning message by e-mail, for example, to the customer's client terminal 20 to indicate that the receive-by date is approaching and prompt the customer to receive the article by the date (step S404). The client terminal 20 receives the warning message (step S405).

Then, at step S406, the locker management server 40 determines whether it has received an article receipt completion notice at step S311. If the locker management server 40 has received the notice, it terminates the receive-by date monitoring step. Otherwise, it determines whether the receive-by date has expired (step S407). If the receive-by date has not expired, the process returns to and repeats step S406 until the receive-by date, and then proceeds to step S408.

At step S408, the locker management server 40 sends a receive-by-date expiration notice to the commerce server 30.

The commerce server 30 receives the expiration notice (step S409) and issues a withdrawal password to be used for withdrawing the article contained in the locker to the locker management server 40 (step S410).

The locker management serve 40 receives the withdrawal password at the successive step S411 and indicates to the delivery management server 60 the type and quantity of the article contained in the locker, the location and number of the locker, the withdrawal password, a place (for example the electronic store, a warehouse in which the article was stored, or a warehouse of locker management company or delivery service company) to which the article withdrawn is to be delivered, and sends a request for withdrawal of the article to the delivery management server 60 (step S412).

The delivery service company receives the withdrawal request on the delivery management server 60 (step S413), and a delivery person of the delivery service company goes to the locker containing the article, uses the withdrawal password to unlock the compartment of he locker, and withdraws the article. Then, the delivery person delivers the withdrawn article to a specified place.

After issuing the withdrawal password at step S411, the commerce server 30 sends by e-mail, for example, to the customer's client terminal 20 a withdrawal notice indicting that the article has been withdrawn because the receive-by date has expired and including a redelivery specification request for customer to specify re-delivery of the article, if desired (step S414). The client terminal 20 receives them (step S415).

After receiving the withdrawal notice and re-delivery specification request on the client terminal 20, the customer specifies a locker and other requirements, as performed at step S104, and provides the specifications to the commerce server 30 if the customer wants re-delivery of the article. In this case, the customer may specify a new password, or use the password he/she has specified previously.

The above-described article delivery system allows an article ordered by a customer to be delivered to one of the lockers 11 installed in various places and allows the customer to receive the article at the specified locker. Because the article is delivered to a locker installed in a place convenient for the customer, the customer can receive the article at a convenient time.

While the receipt password is specified by the customer on order in the above-described embodiment, it may be specified in the commerce server 30 or locker management server 40. It may be possible that the receipt password is not provided to the customer until the customer has completed payment.

While the foregoing exemplary embodiment has been described with respect to Internet shopping in which an article is purchased from an electronic store, the present invention is not limited to Internet shopping. The article delivery system can be used in a case where a customer actually visits a store, purchases an article, and requests delivery of the article, or mail-order sales in which a customer orders an article by telephone or facsimile and requests the delivery of the article, or a case where the customer merely requests the delivery of goods.

The above-described embodiment is configured so as to check availability of a locker to which an article is to be delivered when the article is ordered, and reserves a compartment of the available locker in which the article is to be placed. The present invention is not limited to this embodiment. The delivery person may place the article in any available compartment of the specified locker on delivery and identity that compartment to the recipient of the article.

The orderer and recipient of an article are not necessarily required to be the same person, of course.

Also, the commerce server 30 and the locker management server 40 are not necessarily required to be operated by different companies. They may be operated by a single company or may be combined into a single server. While a locker control server 50 is provided for each of lockers installed in various places in the above-described exemplary embodiment, this is not a necessary condition of the invention and, the lockers 11 may be centrally controlled by the locker control server 50. In this case, the locker management server 40 may provide functions of the locker control server 50.

[Description of symbols]

10 . . . Network

20 . . . Client terminal (terminal)

30 . . . Commerce server (article delivery request receipt apparatus)

32 . . . Article purchase receipt module (order receipt module)

33 . . . Payment receiving module (payment processing module)

34 . . . Receipt setting receiving module (receiving means, locker specification receiving module, or delivery request receiving module)

35 . . . Delivery information issuing module (information output module)

36 . . . Password management module (password registration means or password setting module)

40 . . . Locker management server

42 . . . Availability management module

43 . . . Entry/retrieval management module

44 . . . Receive-by data management module (expiration date management module)

45 . . . Password management module (password registration module)

50 . . . Locker control sever (locker open/close control apparatus)

52 . . . Entry monitoring module (entry control means)

53 . . . Retrieval monitoring module (retrieval control means)

60 . . . Delivery management server

11 . . . Locker

We claim:

1. In a system for performing electronic commerce involving an article over a network and managing a locker for delivery and receipt of the article, an article delivery method comprising the steps of:
receiving an order for the article over said network and setting and storing receipt identification information used to open said locker, said receipt identification information identifying a recipient of said article;
receiving a specification of said locker to which said article is to be delivered;
outputting delivery request data including article identification information identifying said article and locker information indicating said locker; and
after the article is delivered to the locker, unlocking said locker containing said delivered article based on said delivery request data in response to acceptance of said receipt identification information.

2. The article delivery method according to claim 1, wherein said delivery request data output at said step of outputting includes a delivery password used for placing said article into said locker; and said method further comprises a step of locking said locker when said article is placed in said locker and input of said delivery password is accepted.

3. The article delivery method according to claim 2, further comprising a step of invalidating said delivery password after said locker is locked by using said delivery password.

4. The article delivery method according to claim 2, further comprising a step of invalidating said receipt identification information after said locker is unlocked by using said receipt identification information.

5. The article delivery method according to claim 1, further comprising a step of determining whether payment for said ordered article is completed,
wherein said locker is unlocked at said step of unlocking if payment for said ordered article is completed.

6. The article delivery method according to claim 5, further comprising a step of performing a process for payment for said article if payment for said ordered article is not completed,
wherein said locker is unlocked at said step of unlocking after said process for payment is completed.

7. An article delivery system, comprising:
a receipt setting receiving module for receiving specification of a locker to which an article is to be delivered;
a password management module for registering a receipt password used by a recipient of said article to open said locker and a delivery password used by a deliverer of the article to open said locker;
an entry monitoring module for locking said locker when said delivery password is input and said article is placed in said locker; and
a retrieval monitoring module for unlocking said locker containing said article when said receipt password is input.

8. A locker management server, comprising:
a receipt setting receiving module for receiving specification of a locker to which an article is to be delivered; and
a password management module for registering a first password used for unlocking said locker when said article is placed in said locker and a second password used for unlocking said locker when said article is retrieved from said locker.

9. The locker management server according to claim 8, wherein, when a locker or a locker location to which said article is to be delivered is specified in said receipt setting receiving module, availability of said locker or any locker at said locker location is checked and, if said locker or any locker at said locker location is available, the specification of said locker to which said article is to be delivered is accepted.

10. The locker management server according to claim 8, wherein said receipt setting receiving module accepts specification of a valid period during which said delivered article is contained in said locker.

11. The locker management server according to claim 8, further comprising an expiration management module for, if said article contained in said locker is not retrieved within a predetermined period, reporting to an external destination.

12. A locker control server, comprising:
a lock control module for controlling locking and unlocking of a specified locker to which an article is to be delivered;
a password registration module for registering a first password and a second password provided from an external source over a network for unlocking said locker;
an entry monitoring module for unlocking said locker when said first password is input and locking said locker after said article is placed in said locker; and
a retrieval monitoring module for unlocking said locker when said second password is input.

13. The locker control server according to claim 12, wherein said retrieval monitoring module determines whether payment for said article is completed and, if the payment is completed, unlocks said locker to allow said article to be retrieved from said locker.

14. The locker control server according to claim 13, further comprising a payment processing module for processing payment if payment for said article is not completed.

15. The locker control server according to claim 12, further comprising a sensor for detecting whether an article is contained in said locker.

16. A commerce server, comprising:
a receipt setting receiving module for receiving a request for delivery of an article by receiving specification of a locker to which an article is to be delivered and customer identification information identifying a customer provided from a terminal of said customer over a network;
a password management module for setting an unlocking password for unlocking said locker and indicating said unlocking password to said terminal of said customer over said network; and
a delivery information issuance module for outputting locker identification information identifying said locker and article identification information identifying said article for delivering said article to said specified locker.

17. The commerce server according to claim 16, further comprising:
an article purchase order receiving module for receiving an order for an article placed from said terminal of said customer over said network; and
a payment receiving module for receiving payment for said article,
wherein said receipt setting receiving module receives the request for delivery of said article received at said order receiving module.

18. The commerce server according to claim 16, wherein said unlocking password is set through said terminal of said customer over said network.

19. The commerce server according to claim 16, wherein said password management module indicates said unlocking password to said terminal of said customer after payment for said article or payment for delivery of said article is completed.

20. The commerce server according to claim 16, wherein said password management module sets a locking password when said article delivered to said locker is placed in said locker; and
said delivery information issuance module outputs said locking password in addition to said locker identification information and said article identification information.
